(19) United States
(12) Patent Application Publication
(10) Pub. No.: US 2005/0222856 A1
(43) Pub. Date: Oct. 6, 2005

(54) Analysing services provided by means of a communication system

(75) Inventors: Kalevi Kilkki, Espoo (FI); Olli-Pekka Pohjola, Helsinki (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/900,377

(22) Filed: Jul. 28, 2004

(30) Foreign Application Priority Data
Apr. 5, 2004 (GB) 0407737.6

(51) Int. Cl. G06F 17/60

(52) U.S. Cl. 705/1; 705/10

(57) ABSTRACT

A service design planning tool for planning of services offered for users via a communication system. The planning tool allows for the performance of an interaction analyzer function and an optimizer function. The interaction analyzer function allows for analysis of the interaction between technical and economical aspects of a design of services that are offered for users via a communication system. The optimizer function allows for optimization of the design of the services in accordance with a predefined objective and based on data from the interaction analyzer.

### BACKGROUND OF THE INVENTION

1. Field of the Invention

This disclosure relates to analysing of services provided by means of a communication system.

2. Description of the Related Art

A communication system is typically configured to provide communications between two or more entities such as user equipment and/or other nodes associated with the communication system. The communication may comprise, for example, communication of voice, text, data, multimedia and so on. A user equipment connected to a communication system may, for example, be provided with a two-way telephone call or multi-way conference call. A user equipment may also communicate via the communication system with an application providing entity. The application providing entity may comprise, for example, a service provider. A service provider typically provides services by means of at least one application server (AS).

A vide variety of services may be offered via a communications system. The services may be offered by the operator of the communication system, or by a third party service provider. Non-limiting examples of service include voice communication services, data services, messaging services, multimedia services, Push-to-talk services, streaming services, game service and so on, and any combinations of these. Service providers also try to offer services that meet various demands of a diverse user base. Ever increasing number and variety of services is thus offered via communication networks.

The services provided are also becoming increasingly complex by their design. New services and technologies with new requirements are emerging. The new developments may influence the operation and design of user equipments and/or networks.

The overall service design is of utmost importance for any service provider. A service provider has to make numerous decisions in relations to aspects such as the products, pricing, marketing, Quality of Service (QoS) design, network resources, target performance level o the communication system, and so on. Decisions should be based upon appropriate analysis of the operation. The service providing scheme may thus need to be analysed for example when new products or features are introduced, when any business aspect, for example prices, is changed, or just to check if the service offered is competitive enough.

Decisions regarding any aspect of a service design may affect the business of the service provider in various, complex ways. These may be difficult to comprehend without the help of a proper analytical tool.

The decisions may have a significant effect on interferences between various aspects. For example, the effect of pricing on the required capacity through demanded traffic is a crucial issue for a service provider. However, this may be difficult to assess systematically. Moreover, the information related to pricing, traffic and the cost of network capacity may be located in different parts of an organisation, especially if the organization is substantially large. It is not uncommon that pricing decisions are made by one department of an organization, technical network planning in another department, and traffic monitoring in a third department. An example of a decision to change an aspect is to change the pricing structure. For example, a pricing stricture may be changed from volume based charging to flat rate based charging. This, however, may have a momentous effect on offered traffic. In a specialized organization, the change in the traffic may be noticed only afterwards by the respective department. Required capacity upgrades may be planned only after that, and upgrade may be provided only after the planning stage, and perhaps after ordering and assembling new equipment. Another example is where an operator of packet switched communication network decides to introduce a pure flat rate pricing without any transmission limits. The operator may eventually be forced to change the pricing scheme because of excessive use of resources by a minority of users. Although they can solve the capacity problem by changing their pricing principles, they then have to cope with aggravated users.

A yet another example relates streaming applications. A service provider may have a substantially good understanding about the value of video streaming service based on market analysis. However, if that information is not used when a service quality model is designed, the outcome may turn out to be disastrous.

The consequences of a per se simple decision could be disastrous for the service provider. This might be especially the case with service quality. It might therefore be advantageous to be able to systematically manage the whole process.

Service providers have commonly tried to master the problem by dividing the service design into several sub-areas, like marketing, pricing, traffic engineering and network planning. For each of those areas there are specific tools and specialists who use the tools to solve the specific problems of the area. Because the limited area also limits the design objectives, the optimal design within the sub-area may, however, not be optimal from the overall business perspective. Even if the objective is in the business issues, the limited scope forces to make assumption in the other sub-areas, because in reality all the areas are closely interrelated. Thus approaches with separate design and optimisation may induce serious difficulties. Inputs may be complex and the interpretation of results may require expertise in each of the fields.

The overall problem covering different areas, such as from technical mechanisms to marketing aspects, may be too difficult to assess with separate tools. A tool for systematic assessment of all relevant issues might be advantageous.

### SUMMARY OF THE INVENTION

Embodiments of the present invention aim to address one or several of the above problems.

According to one embodiment there is provided a service design planning tool for planning of services offered for users via a communication system. The planning tool provides an interaction analyser function and an optimiser function. The interaction analyser function is configured to analyse interaction between technical and economical aspects of a design of services that are offered for users via a communication system. The optimiser function is configured to optimise the design of the services in accordance with a predefined objective and based on data from the interaction analyser.

Embodiments may enable service providers to analyse their services and to optimise their operation. Aspects of a number of services considered as being important may be analysed simultaneously. No separate, possibly conflicting analyses may be required. Business objectives may be set to be an important optimisation criterion. A common scale for comparison of different aspects of service design may be provided. Interdependences between different aspects of a service providers operation may be built in a model. Need to separately estimate dependences between different analyses may be avoided.

### BRIEF DESCRIPTION OF DRAWINGS

For better understanding of the present invention, reference will now be made by way of example to the accompanying drawings in which:

FIG. 1 shows communication system;

FIG. 2 is a diagram showing decisions a service provide may make and their implications;

FIG. 3 presents the overall structure of an expert system; and

FIG. 4 presents more detailed structure of an expert system.

### DETAILED DESCRIPTION OF THE PREFERRED EMBODIMENTS

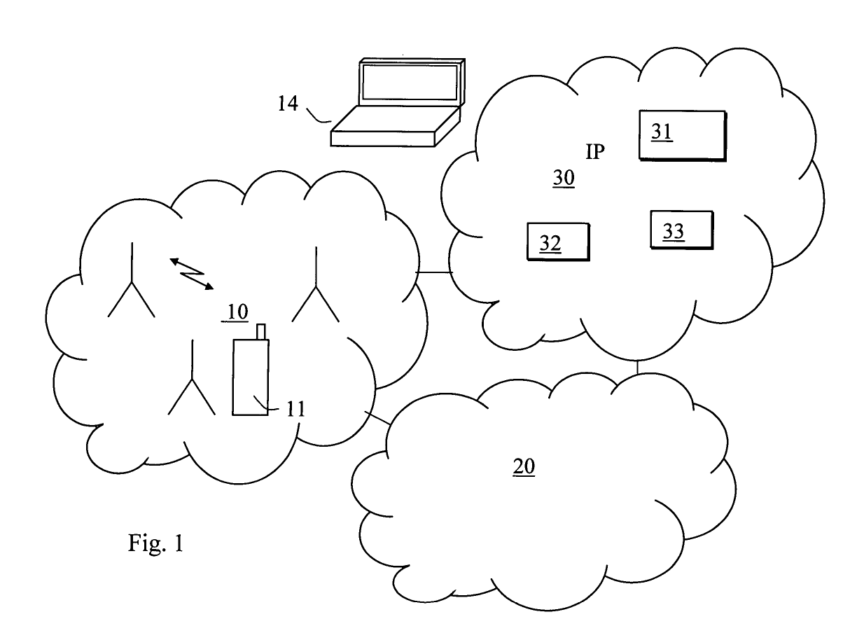

Reference is first made to FIG. 1 which shows a communication system comprising three different networks 10, 20 and 30. More particularly, the exemplifying communication system comprises a wireless network 10 proving wireless communication for a user equipment 11, a fixed line network 20 and a data network 30. The networks interface each other by appropriate arrangements. For example, one or more gateway nodes may be provided for connecting the communication networks to each other.

In a wireless system such as the network 10 communication occurs on a wireless interface between a user equipment 11 and the elements of the communication system. The wireless communication can be based on an appropriate communication protocol. Wireless systems are commonly referred to as mobile systems. An example of the mobile systems is the public land mobile network (PLMN). A PLMN is commonly based on cellular architecture. In a typical cellular architecture a base transceiver station (BTS) serves mobile stations (MS) or similar mobile user equipment (UE) 11 via an air or radio interface. A base station provides a radio access entity that is typically but not exclusively referred to as a cell. Another example is a mobile system that is based, at least partially, on use of communication satellites. Mobile communications may also be provided by means of other mobile systems, such as by means of wireless local area networks (WLAN).

From the other communication networks the data network 30 may be as an IP (Internet Protocol) and/or other packet switched data network 30. The fixed line network 20 may be any appropriate communication network providing fixed line communications for the users thereof.

Each communication network provides communication resources. For example communication resources include network resources such as base stations, links, nodes, and servers, their capacities and capabilities, and coverage in cellular network.

The mobile user equipment 11 of FIG. 1 may comprise any appropriate mobile user equipment adapted to connect the network 10. The user equipment is preferably adapted for Internet Protocol (IP) communication with entities locate in the data network 30. For example, the mobile user may access the cellular network by means of a Personal computer (PC), Personal Data Assistant (PDA), mobile station (MS) and so on. The following examples are described with reference to mobile stations.

The user equipment may connect, via the communication network 10, to various service provider entities 32, 33 and 34 providing service applications and connected to the data network 30. For example, the user may connect to servers that are generally connected to an external packet data network, for example to an Internet Protocol (IP) network. The data processing functions of the application servers may be provided by means of one or more data processor entities. Appropriately adapted computer program code product may be used for implementing the servers. It shall be appreciated that the user equipment 11 may communicate with application servers provided in different data networks.

A service product offered by a service provider may consists of a set of end-user services that have features like technical properties, availability, usability, content, expected quality, and quality requirements. Information associated with quality design aspects of a service may comprise information regarding prioritization of users and/or services and/or applications, resource allocation, buffering structures and so on.

A target performance level may also be defined. Information on target performance level in a communication system may comprise information regarding block rates, delays, drop rates, success rates, throughput, delivery times for different services and/application and/or users.

In an embodiment the business of a service provider is analysed and optimized by means of an analysing tool, referred to hereinafter as expert system. In FIG. 1 the expert system is provided by a data processing device 14. The expert system may process data associated with various aspects of the service design such as product portfolio, network resources, service quality design, and targeted performance level of the network. An aim of the analysis is to be able to justify any actions taken in regards of various aspects in a system providing services to end-users. These aspects may comprise quality aspects or any other aspects considered as relevant.

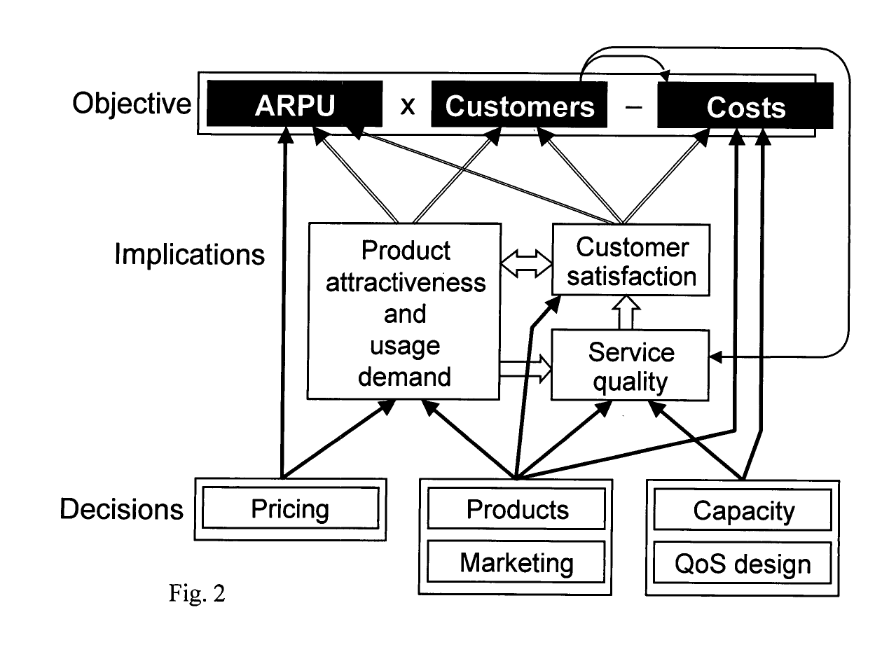

The embodiment provides an expert system that is configured to analyse and optimise various design aspects of the service provider's services. Non-limiting examples of the aspects include product portfolio including offered services, the properties of the services, pricing, and marketing. Further examples include network resources such as available network elements, and capacities and capabilities of network elements, and Quality of Service (QoS) design such as applied prioritisation, resource allocation, and buffering structures, and so on. Further examples include target performance level such as block rates, delays, drop rates, success rates, throughput, delivery times for different services and/or applications and/or users. Some possible aspects and their interaction are shown in FIG. 2.

The expert system may be configured to analyse the implications of the service design to the business measures. Non-limiting examples of such measures include revenue, cost, and customer satisfaction. The expert system may then optimise the service design according to a set objective.

The concept may be based on holistic service design in which an objective shall justify all aspects of service design. An expert system may be used to assess all relevant aspects of mobile service design within one comprehensive model. This may be performed simultaneously and in a single scale. In this context the term ‘relevant’ is intended to mean those aspects of a service design which are interdependent and may have a significant effect on the business of a service provider, either directly or indirectly.

The expert system may analyse implications of the service design from the demand and network perspective to economical measures such as revenue, cost, and customer satisfaction. The output from the analysis can be used to optimise the service design. The analysis may include detailed consideration of customer needs, capabilities, resources, and behaviour. The analyser tool enables service providers to optimise service designs.

The analyser tool may be configured to provide assessment of all relevant aspects of service design at the same time and in the same scale, to provide a simultaneous analysis of implications of service design from demand and network perspective into revenue, cost, and customer satisfaction measures, and to provide optimisation of total service design according to a business objective.

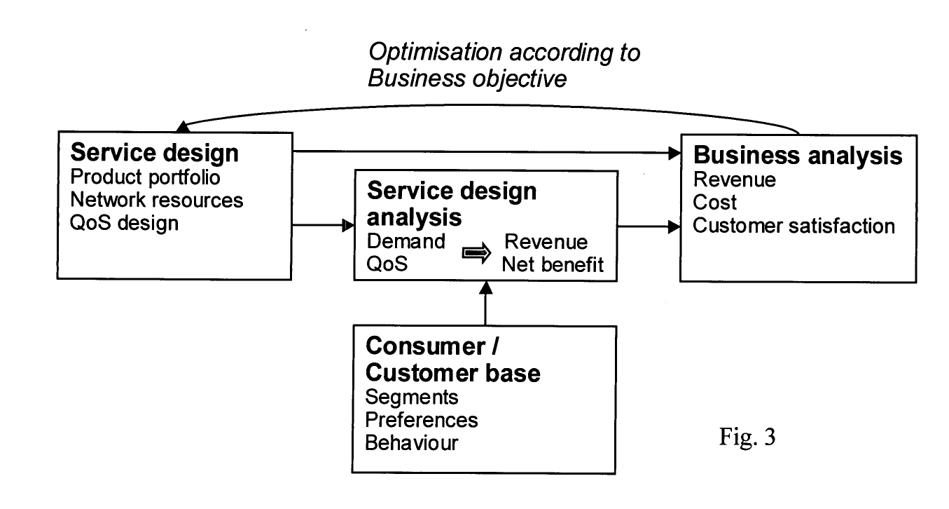

FIG. 3 shows a possible block diagram for high-level service analysis and optimisation process in an expert analyser system. The expert system may be operationally divided into a number of functional blocks. For example, the operation may be divided into functional blocks such as definition of service design, definition of consumer base, service design analysis, and business analysis. The arrangement may be such that a service design is optimised based on output from a business analysis part of an analyser.

Possible configurations of these functional blocks of an expert analyser system, their functions, inputs, and outputs are explained in more detail below.

The service design block 22 may define all relevant aspects of the service design. Information input into the analysis may include information about product portfolio, network resources, Quality of Service (QoS) design, and target performance level.

Product portfolio may include information such as offered products, their pricing, and marketing. Products of a service provider comprise end-user services. The products may be defined by technical properties, availability, usability, content, expected quality, QoS requirements, and so on.

Network resources define the resources available for the services, network elements and their capabilities and capacities that affect the service quality, and service coverage.

QoS design defines the QoS actions and mechanisms in the network. Examples of these include prioritisation of packets and flows, buffering structures, and resource allocation.

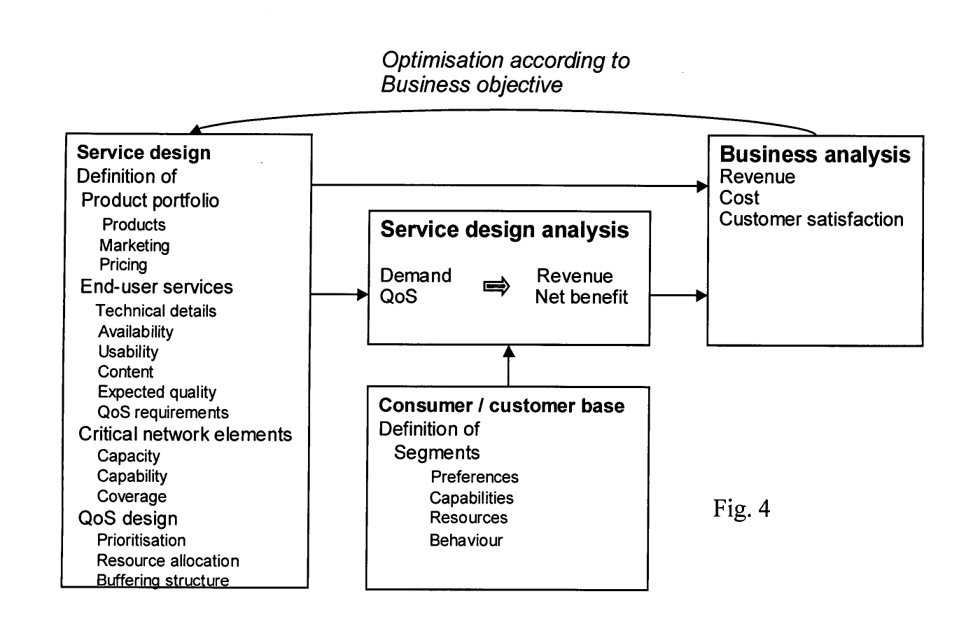

A more detailed example of the service design block 22 is given in FIG. 4.

Block 24 is for defining users or consumers of the services. Users may be divided into segments according to their needs, capabilities, resources, and behaviour. Needs generate demand for preferred services that may be described, for example, by their technical properties, content, availability, usability, price, and quality. Benefits and costs from a preferred service may depend on these features and user capabilities and resources. Benefits and costs can be given as a function of usage demand. User behaviour is preferably defined as a function of marketing, price, usability, availability, content, nature of the market, service substitutes, time, area of use, and perceived quality.

The function of the service design analysis block 26 is to analyse the implications of various aspects of service design into revenues and net benefits of users. The service design may be analysed from user demand and network performance perspectives. Demand perspective compares the product portfolio against the user preferences, and generates demand for each service product. Network perspective analyses the generated traffic in the network and calculates network quality levels for the end-user services. Common demand and quality level analysis gives the operator's revenue and user's net benefit for the services, and service usage. Information about the service usage may be fed back to traffic analysis function.

Business analysis block 28 may then calculate the revenue, cost, and user satisfaction for the analysed service design, and optimise the service design in accordance with a set objective. Revenue may be calculated in various dimensions from the results of service design analysis. Total cost includes costs due to service design, e.g. capital expenditure (CAPEX) costs due to network elements and operational expenditure (OPEX) costs due to dissatisfied customers. User satisfaction may depend on user needs and preferences and net benefits from offered services.

The required data processing functions of an expert system may be provided by means of one or more appropriate data processor entities. An appropriately adapted computer program code product may be used for implementing the embodiments, when loaded to a computer, for example for performing the computations and for retrieving and analysing information.

The data processing may be provided by means of an external analyzer tool, such as the data processing device 14 of FIG. 1. The external analyzer tool may be used by service provider when designing and optimizing offered services and network. The expert system may also be integrated with a service provider server. The analyzing tool may also be connected to a communication network to optimize some parameters thereof.

The program code product may be stored on and provided by means of a carrier medium such as a carrier disc, card or tape. A possibility is to download the program code product via a data network.

The expert system may thus optimise the service design to satisfies criteria set forth by a business objective. A simplified example of a business objective is given below:

Maximize: Total profit=Total revenue−Total cost subject to: Customer satisfaction=90%.

The embodiment of the present invention has been described in the context of a communication system comprising mobile networks and packet switched data networks. This invention is also applicable to any other communication systems including local area networks, fixed line networks as well as any hybrids of any appropriate networks. It shall also be appreciated that whilst embodiments of the present invention have been described in relation to user equipment such as mobile stations communicating via a mobile system, embodiments of the present invention are applicable to any other suitable type of user equipment.

It is also noted herein that while the above describes exemplifying embodiments of the invention, there are several variations and modifications which may be made to the disclosed solution without departing from the scope of the present invention as defined in the appended claims.

1. A service design planning tool for planning of services offered to users via a communication system, the planning tool comprising:
an interaction analyzer configured to analyze interaction between technical and economical aspects of a design of services that are offered for users via a communication system; and
an optimizer configured to optimize the design of the services in accordance with a predefined objective and based on data from the interaction analyzer.

2. The planning tool as claimed in claim 1, wherein the planning tool is configured to process input information that is associated with at least one of a service portfolio, network resources, operation of a network, and service quality.

3. The planning tool as claimed in claim 2, wherein the information is associated with the service portfolio, and includes information associated with at least one of offered services, technical properties, pricing, marketing, quality requirements, content, nature of a service market, availability, usability, and quality of the services.

4. The planning tool as claimed in claim 2, wherein the information includes information associated with the network resources, and includes information associated with network elements.

5. The planning tool as claimed in claim 4, wherein the information associated with the network elements includes information associated with at least one of availability, capacity, and capabilities of at least one network element.

6. The planning tool as claimed in claim 2, wherein the information includes information associated with the operation of the network and includes information that is associated with cost of operation of the network.

7. The planning tool as claimed in claim 2, wherein the information including information associated with the service quality and comprises information associated with at least one of quality of service design and target performance level.

8. The planning tool as claimed in claim 7, wherein the information associated with the quality of service design includes information associated with at least one of prioritization, resource allocation, and buffering.

9. The planning tool as claimed in claim 7, wherein the information including information associated with the target performance level and includes information associated with at least one of block rates, delays, drop rates, success rates, service throughputs, and delivery times.

10. The planning tool as claimed in claim 1, wherein the economical aspects comprise a measure for at least one of revenue, cost, and user satisfaction.

11. The planning tool as claimed in claim 1, wherein the interaction analyzer is further configured to analyze an interaction of demand aspects with other aspects of the design of the services that are offered for the users via the communication system.

12. The planning tool as claimed in claim 1, wherein the interaction analyzer is further configured to analyze interaction of aspects that include at least one of needs of the users, preferences, usage demand, net benefits, benefits, costs, revenues, resources, capabilities, and behavior of the users with other aspects of the design of services that are offered for the users via the communication system.

13. The planning tool as claimed in claim 1, wherein the optimizer optimizes in accordance with a business objective.

14. A method for planning of service designs for services provided via a communication system, the method comprising the steps of:
analyzing interaction between technical and economical aspects of a design of services offered for users via a communication system; and
optimizing the design of the services in accordance with a predefined objective and based on data from the interaction.

15. The method as claimed in claim 14, further comprising:
processing input information that is associated with at least one of a service portfolio, network resources, and service quality.

16. The method as claimed in claim 14, further comprising:
processing a measure for at least one of revenue, cost, and user satisfaction.

17. The method as claimed in claim 14, further comprising processing information to analyze interaction of demand aspects with other aspects of a design of the services that are offered for the users via the communication system.

18. A computer program embodied on a computer readable medium, said computer program controlling a computer to execute a process comprising:
analyzing interaction between technical and economical aspects of a design of services offered for users via communication system; and
optimizing the design of the services in accordance with a predefined objective and based on data from an interaction analyzer.

19. A control system for planning of service designs for services provided via a communication system, the control system comprising:
analyzing means for analyzing interaction between technical and economical aspects of a design of services offered for users via a communication system; and
optimizing means for optimizing the design of the services in accordance with a predefined objective and based on data from said analyzing means.
